(19) United States
(12) Patent Application Publication
(10) Pub. No.: US 2026/0269760 A1
(43) Pub. Date: Sep. 10, 2026

(54) MOTOR DRIVING DEVICE AND METHOD OF CONTROLLING SAME

(71) Applicants: Hyundai Motor Company, Seoul (KR); Kia Corporation, Seoul (KR)

(72) Inventors: Myeong Won KIM, Hwaseong-si (KR); Dong Kyu YU, Hwaseong-si (KR); Young Ho CHAE, Hwaseong-si (KR)

(73) Assignees: Hyundai Motor Company, Seoul (KR); Kia Corporation, Seoul (KR)

(21) Appl. No.: 19/664,669

(22) Filed: Apr. 30, 2026

(30) Foreign Application Priority Data
Jun. 24, 2005 (KR) 10-2025-0083783

(51) Int. Cl. H02P 27/06; H02P 23/00; H02P 23/14; H02P 29/68

(52) U.S. Cl. CPC H02P 27/06; H02P 23/0027; H02P 23/14; H02P 29/68

(57) ABSTRACT

In a motor driving device and a method of controlling the same to determine a driving mode of a motor in consideration of the temperature of a switch that switches the driving mode, the motor driving device includes a motor including a plurality of windings, a first inverter connected to a first end of each of the windings, a second inverter connected to a second end of each of the windings, a mode switch including a plurality of switching elements, ends of one side of each of the switching elements being interconnected, opposite ends of the switching elements being connected to the second ends of the windings, and a controller configured to determine a driving mode of the motor based on an operating parameter value of the motor and a temperature of the mode switch and to control the switching elements based on the determined driving mode.

### CROSS-REFERENCE TO RELATED APPLICATION

The application claims priority from Korean Patent Application No. 10-2025-0083783, filed on Jun. 24, 2025, in the Korean Intellectual Property Office, the present disclosure of which is incorporated herein for all purposes by this reference.

### BACKGROUND OF THE PRESENT DISCLOSURE

### Field of the Present Disclosure

The present disclosure relates to a motor driving device and a method of controlling the same, and more specifically, to a motor driving device and a method of controlling the same to determine a driving mode of a motor in consideration of the temperature of a switch that switches the driving mode of the motor.

### Description of Related Art

In general, ends of one side of each of the windings of phases included in a motor are connected to an inverter and the other ends are connected to each other to form a Y-connection.

When the motor is driven, a switching element in the inverter is turned on/off by pulse width modulation control so that a line voltage is applied to the Y-connected windings of the motor to generate an alternating current, thereby generating torque.

The fuel efficiency (or power efficiency) of an eco-friendly vehicle such as an electric vehicle that utilizes the torque generated by such a motor as power is determined by the power conversion efficiency of the inverter-motor, and thus it is important to maximize the power conversion efficiency of the inverter and the efficiency of the motor in order to improve fuel efficiency.

The efficiency of the inverter-motor system is mainly determined by the voltage utilization rate of the inverter, and if the operating point of the vehicle determined the relationship between the motor speed and torque is formed in a range in which the voltage utilization rate is high, the fuel efficiency of the vehicle can be improved.

However, as the number of windings of the motor is increased in order to increase the maximum torque of the motor, the range with a high voltage utilization rate becomes farther away from a low torque area, which is the main operating point of the vehicle, and thus the fuel efficiency can be reduced. Furthermore, if the main operating point is designed to be included in the range with high voltage utilization rate from the perspective of fuel efficiency, the maximum torque of the motor may be limited, which may deteriorate the starting performance.

In the Field of the present disclosure, as motor driving technology capable of improving system efficiency while covering both low-power and high-power ranges with one motor is required, technology for driving one motor in two different modes using two inverters and a mode switch has been introduced recently.

The matters described as the background technology above are only for the purpose of facilitating the understanding of the background of the present disclosure, and should not be accepted as acknowledging that they correspond to related art already known to those skilled in the art.

### BRIEF SUMMARY

Various aspects of the present disclosure are directed to providing a motor driving device and a method of controlling the same for controlling driving of a motor more efficiently by considering the temperature of a mode switch.

The aspects to be achieved through the embodiments of the present disclosure are not limited to the aspect mentioned above, and other aspects that are not mentioned will be clearly understood by those skilled in the art from the description below.

In accordance with an aspect of the present disclosure, the above and other aspects can be accomplished by the provision of a motor driving device including a motor including a plurality of windings, a first inverter connected to a first end of each of the winding, a second inverter connected to a second end of each of the windings, a mode switch including a plurality of switching elements, ends of one side of each of the switching elements being interconnected, opposite ends of the switching elements being connected to the second ends of the windings, and a controller configured to determine a driving mode of the motor based on an operating parameter value of the motor and a temperature of the mode switch and to control the switching elements based on the determined driving mode.

For example, the controller may be configured to determine a driving mode switching criterion of the motor based on the temperature of the mode switch, and determine the driving mode of the motor based on the determined driving mode switching criterion and the operating parameter value of the motor.

For example, the controller may apply a predetermined margin range to the determined driving mode switching criterion, and determine the driving mode of the motor based on whether the operating parameter value of the motor deviates from the margin range for a predetermined time period or longer than the predetermined time period.

For example, operating parameter values of the motor may include at least one of a torque, a reverse magnetic flux, or a rotation speed of the motor.

For example, the driving mode switching criterion may be determined based on relationships between the torque and the reverse magnetic flux of the motor or relationships between the torque and the rotation speed of the motor corresponding to different temperatures in a preset temperature range of the mode switch.

For example, the driving mode may include a closed end winding (CEW) mode in which the switching elements are turned on to form a Y-connection and the first inverter is controlled by the controller to drive the motor, and an open end winding (OEW) mode in which the switching elements are turned off by the controller and the first inverter and the second inverter are controlled by the controller to drive the motor.

For example, the controller may be configured to control the switching elements in the determined driving mode, based on the determined driving mode being different from a driving mode of the motor determined in a previous control cycle.

For example, the controller may be configured to control the switching elements in the driving mode determined in the previous control cycle, based on the driving mode of the motor determined in the previous control cycle being the same as the determined driving mode.

In accordance with another aspect of the present disclosure, there is provided a method of controlling a motor driving device including a motor including a plurality of windings, a first inverter connected to a first end of each of the windings, a second inverter connected to a second end of each of the windings, a mode switch including a plurality of switching elements, ends of one side of each of the switching elements being interconnected, opposite ends of the switching elements being connected to the second ends of the windings, and a controller, the method including determining, by the controller, a driving mode of the motor based on an operating parameter value of the motor and a temperature of the mode switch, and controlling, by the controller, the switching elements based on the determined driving mode.

For example, the determining of the driving mode may include determining, by the controller, a driving mode switching criterion of the motor based on the temperature of the mode switch, and determining, by the controller, the driving mode of the motor based on the determined driving mode switching criterion and the operating parameter value of the motor.

For example, the determining of the driving mode may include applying, by the controller, a predetermined margin range to the determined driving mode switching criterion, and determining, by the controller, the driving mode of the motor based on whether the operating parameter value of the motor deviates from the margin range for a predetermined time period or longer than the predetermined time period.

For example, operating parameter values of the motor may include at least one of a torque, a reverse magnetic flux, or a rotation speed of the motor.

For example, the driving mode switching criterion may be determined based on relationships between the torque and the reverse magnetic flux of the motor or relationships between the torque and the rotation speed of the motor corresponding to different temperatures in a preset temperature range of the mode switch.

For example, the driving mode may include a closed end winding (CEW) mode in which the switching elements are turned on to form a Y-connection and the first inverter is controlled by the controller to drive the motor, and an open end winding (OEW) mode in which the switching elements are turned off by the controller and the first inverter and the second inverter are controlled by the controller to drive the motor.

For example, the controlling of the switching elements may include controlling, by the controller, the switching elements in the determined driving mode, based on the determined driving mode being different from a driving mode of the motor determined in a previous control cycle.

For example, the controlling of the switching elements may include controlling, by the controller, controlling the switching elements in the driving mode determined in the previous control cycle, based on the driving mode of the motor determined in the previous control cycle being the same as the determined driving mode.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a circuit diagram of a motor driving device according to an exemplary embodiment of the present disclosure;

FIG. 2 shows a first operating point region and a second operating point region on a graph of a command torque and a reverse magnetic flux of a motor according to an exemplary embodiment of the present disclosure;

FIG. 3 is a circuit diagram of the motor driving device according to an exemplary embodiment of the present disclosure when the motor driving device operates in a closed end winding (CEW) mode;

FIG. 4 shows a third operating point region and a fourth operating point region considering on-resistance of a plurality of third switching elements on a graph of a command torque and a reverse magnetic flux of a motor according to an exemplary embodiment of the present disclosure;

FIG. 5 shows a change pattern of the third operating point region considering on-resistance according to temperature change in the plurality of third switching elements in an exemplary embodiment of the present disclosure;

FIG. 6 shows an example of a process in which a controller according to an exemplary embodiment of the present disclosure is configured to determine a driving mode of the motor and is configured to control the plurality of third switching elements;

FIG. 7, FIG. 8, and FIG. 9 illustrate a method of determining a driving mode by applying a predetermined margin range to a driving mode switching criterion determined by the controller according to an exemplary embodiment of the present disclosure;

FIG. 10 illustrates an example of a process in which the controller according to an exemplary embodiment of the present disclosure is configured to determine a driving mode in more detail; and

FIG. 11 illustrates an example of a process of controlling the plurality of third switching elements based on a driving mode determined by the processor according to an exemplary embodiment of the present disclosure in more detail.

### DETAILED DESCRIPTION

Specific structural and functional descriptions of the embodiments of the present disclosure, disclosed in the present specification, are merely illustrative for the purpose of explaining the embodiments according to an exemplary embodiment of the present disclosure, and the exemplary embodiments of the present disclosure may be implemented in various forms and should not be construed as being limited to the embodiments described in the present specification or application.

Since the exemplary embodiments of the present disclosure can be modified in various manners and have various forms, specific embodiments will be illustrated in the drawings and described in detail in the specification or application. However, this is not intended to limit the embodiments according to the concept of the present disclosure to a specific disclosed form, and should be understood to include all changes, equivalents, and substitutes included in the spirit and technical scope of the present disclosure.

All terms including technical or scientific terms include the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in an exemplary embodiment of the present disclosure, such terms should not be interpreted in an ideal or excessively formal manner.

Hereinafter, various exemplary embodiments disclosed in the present specification will be described in detail with reference to the appended drawings. However, identical or similar components will be assigned the same reference numeral, and redundant descriptions thereof will be omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit” or “part” used to signify components are used herein to aid in understanding of the components and thus they should not be considered as having specific meanings or roles.

In the following description of the embodiments disclosed in the present specification, a detailed description of known functions and configurations incorporated herein will be omitted when it may obscure the subject matter of the present disclosure. Furthermore, the accompanying drawings are disposed only for ease of understanding of the embodiments disclosed in the present specification, do not limit the technical spirit disclosed herein, and include all changes, equivalents and substitutes within the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

Furthermore, “unit” or “control unit” included in a motor control unit (MCU), a hybrid control unit (HCU), etc., is merely a term widely used to name a controller that is configured to control a vehicle-specific function and does not mean a generic functional unit.

A controller may include a communication device that communicates with other controllers or sensors to control the functions thereof, a memory that stores an operating system, logic instructions, and input/output information, and one or more processors that perform determination, calculation, decisions, etc. necessary to control the functions thereof.

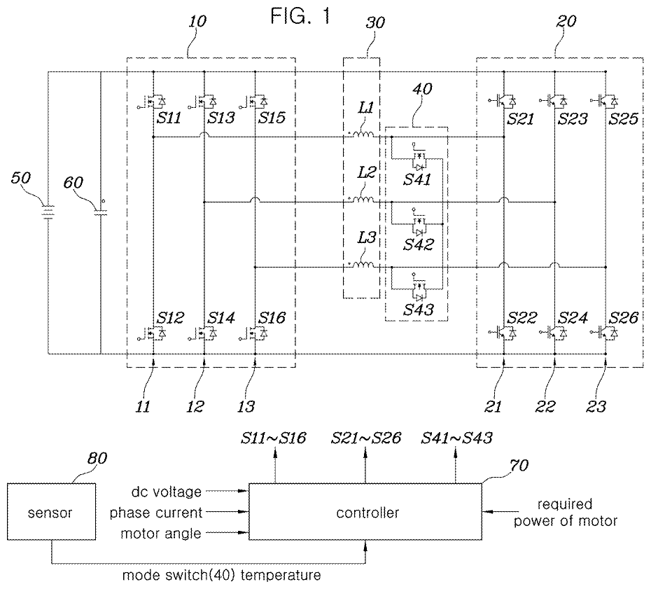

FIG. 1 is a circuit diagram of a motor driving device according to an exemplary embodiment of the present disclosure.

Referring to FIG. 1, the motor driving device according to an exemplary embodiment of the present disclosure may include a first inverter 10, a second inverter 20, a motor 30 having a plurality of windings L1, L2, and L3 corresponding to a plurality of phases, a mode switch 40, a battery 50, a DC capacitor (or DC-link capacitor) 60, a controller 70, and a sensor 80.

The first inverter 10 may include a plurality of first switching elements S11, S12, S13, S14, S15 and S16 connected to first ends of the plurality of windings L1, L2, and L3, and the second inverter 20 may include a plurality of second switching elements S21, S22, S23, S24, S25 and S26 connected to second ends of the plurality of windings L1, L2, and L3. The mode switch 40 may include a plurality of third switching elements S41, S42, and S43. Ends of one side of each of the third switching elements S41, S42, and S43 are respectively connected to the second ends of the plurality of windings L1, L2, and L3, and the other ends thereof may be interconnected. The node at which the other ends of the third switching elements S41, S42, and S43 are interconnected may serve as a neutral point of the motor 30 when the third switching elements S41, S42, and S43 are turned on.

The controller 70 may control on/off states of the first switching elements S11, S12, S13, S14, S15, and S16, the second switching elements S21, S22, S23, S24, S25, and S26, and the third switching elements S41, S42, and S43 based on required power of the motor (i.e., a torque command for the motor), a DC-link voltage of the inverters 10 and 20 (i.e., the voltage of the battery), the phase current of the motor, and the motor angle. The sensor 80 may detect the temperature of the mode switch 40.

The first inverter 10 may include a plurality of legs 11, 12, and 13 to which a DC voltage generated in the DC capacitor 60 connected between both ends of the battery 50 is applied. The legs 11, 12, and 13 may be electrically connected to the plurality of phases of the motor 30.

The first leg 11 includes two switching elements S11 and S12 that are connected in series between both ends of the DC capacitor 60, and the connection node of the two switching elements S11 and S12 may be connected to the first end of the winding L1 of one phase among the plurality of phases within the motor 30 so that AC power corresponding to the one phase is input and output. Similarly, the second leg 12 includes two switching elements S13 and S14 that are connected in series between both ends of the DC capacitor 60, and the connection node of the two switching elements S13 and S14 may be connected to the first end of the winding L2 of one phase within the motor 30 so that AC power corresponding to the one phase is input and output. Furthermore, the third leg 13 includes two switching elements S15 and S16 that are connected in series between both ends of the DC capacitor 60, and the connection node of the two switching elements S15 and S16 may be connected to the first end of the winding L3 of one phase of the motor 30 so that AC power corresponding to the one phase is input and output.

The second inverter 20 may include a plurality of legs 21, 22, and 23 to which the DC voltage generated the DC capacitor 60 connected between both ends of the battery 50 is applied. The legs 21, 22, and 23 may be electrically connected to the plurality of phases of the motor 30.

The first leg 21 includes two switching elements S21 and S22 that are connected in series between both ends of the DC capacitor 60, and the connection node of the two switching elements S21 and S22 may be connected to the second end of the winding L1 of one phase among the plurality of phases within the motor 30 so that AC power corresponding to the one phase is input and output. Similarly, the second leg 22 includes two switching elements S23 and S24 that are connected in series between both ends of the DC capacitor 60, and the connection node of the two switching elements S23 and S24 may be connected to the second end of the winding L2 of one phase within the motor 30 so that AC power corresponding to the one phase is input and output. Furthermore, the third leg 23 includes two switching elements S25 and S26 that are connected in series between both ends of the DC capacitor 60, and the connection node of the two switching elements S25 and S26 may be connected to the second end of the winding L3 of one phase within the motor 30 so that AC power corresponding to the one phase is input and output.

Ends of one side of each of the plurality of third switching elements S41, S42, and S43 may be interconnected to form a Y-connection, and other ends thereof may be connected to the second ends of the plurality of windings L1, L2, and L3 included in the motor 30. Various switching means known in the art, such as MOSFETs, IGBTs, thyristors, and relays may be adopted as the third switching elements S41, S42, and S43.

Although not illustrated in FIG. 1, the motor driving device may further include a so-called Y-capacitor (Y-Cap) in which two capacitors are connected in series between a positive (+) DC terminal and a negative (−) DC terminal, and the connection node of the capacitors is grounded.

The controller 70 may control the motor 30 to be driven by switching the switching elements S11, S12, S13, S14, S15, S16, S21, S22, S23, S24, S25, and S26 included in the first inverter 10 and the second inverter 20 through pulse width modulation control based on the required power of the motor 30.

Furthermore, the controller 70 may control on/off states of the plurality of third switching elements S41, S42, and S43 included in the mode switch 40 according to a motor driving mode. The motor driving mode may include a first driving mode and a second driving mode. Here, the first driving mode may be referred to as a “closed end winding (CEW) mode” and the second driving mode may be referred to as an “open end winding (OEW) mode”.

The controller 70 may control the plurality of third switching elements S41, S42, and S43 to be turned on and drive the motor 30 through the first inverter 10 in the CEW mode. In the ON state, the third switching elements S41, S42, and S43 may form the neutral point of the motor 30 through the node at which the ends of one side of each of the third switching elements are interconnected.

On the other hand, the controller 70 may control the third switching elements S41, S42, and S43 to be turned off and drive the motor 30 through the two inverters 10 and 20 in the OEW mode. The third switching elements S41, S42, and S43 may electrically separate the node at which ends of one side of each of the third switching elements S41, S42, and S43 are interconnected from the second ends of the plurality of windings L1, L2, and L3 in the OFF state, and the node at which the ends of one side of each of the third switching elements are interconnected does not form the neutral point of the motor.

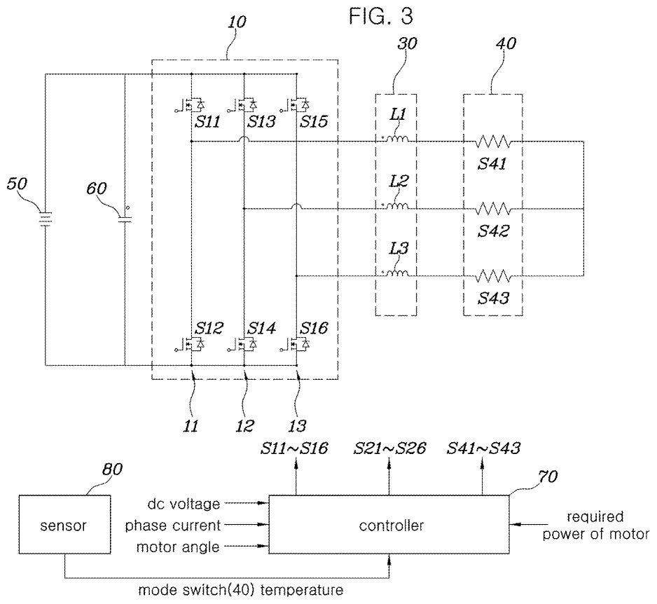

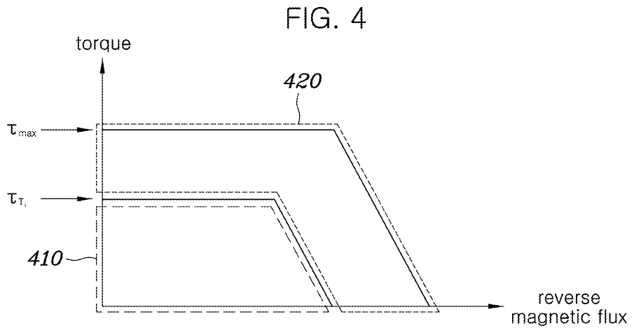

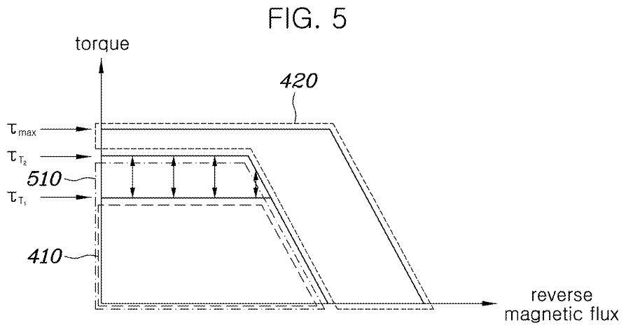

The sensor 80 may detect the temperature of the mode switch 40 and provide the detected temperature information to the controller 70. The controller 70 may be configured to determine a switching criterion for the first driving mode and the second driving mode based on the received temperature information, which will be described in more detail with reference to FIG. 3, FIG. 4 and to FIG. 5 below.

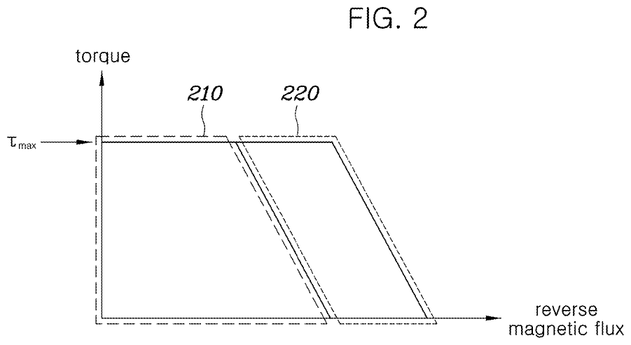

Hereinafter, driving mode switching of the motor according to an exemplary embodiment of the present disclosure will be described below with reference to FIG. 2.

FIG. 2 shows a first operating point region 210 and a second operating point region 220 on a graph of a command torque and a reverse magnetic flux of the motor 30 according to an exemplary embodiment of the present disclosure.

The first operating point region 210 corresponds to the CEW mode. The controller 70 may be configured to determine the driving mode of the motor 30 as the CEW mode based on a current target operating point of the motor 30 belonging to the first operating point region 210.

The motor driving device according to an exemplary embodiment of the present disclosure can form a required driving torque using the first inverter 10 without using the second inverter 20 in the first operating point region 210, and thus can reduce power consumption compared to the case where multiple inverters 10 and 20 are used. The first operating point region 210 corresponds to a low-speed range in which the reverse magnetic flux of the motor 30 is low. Since the rotation speed of the motor 30 is relatively low, the induced counter electromotive force is also relatively low, and accordingly, the voltage required to drive the motor 30 may also be low.

The second operating point region 220 corresponds to the OEW mode. The controller 70 may be configured to determine the driving mode of the motor 30 as the OEW mode based on the current target operating point of the motor 30 belonging to the second operating point region 220.

The motor driving device according to an exemplary embodiment of the present disclosure can form a required driving torque by controlling the first inverter 10 and the second inverter 20 together in the second operating point region 220. The second operating point region 220 corresponds to a high-speed range in which the reverse magnetic flux of the motor 30 is high. Since the rotation speed of the motor 30 is relatively high, the induced counter electromotive force is also relatively high, and accordingly, the voltage required to drive the motor 30 may also be high. Under such voltage conditions, the motor driving device has a limit in generating the current required to drive the motor 30 using the first inverter 10. Therefore, in the second operating point region 220, a sufficiently high phase voltage may be applied to the motor 30 in order to output the required torque even under high counter electromotive force conditions, and to the present end, the controller 70 may control the first inverter 10 and the second inverter 20 together to provide the required voltage to the motor 30.

The controller 70 can control the first inverter 10 among the first inverter 10 and the second inverter 20 to output a maximum torque τₘₐₓ in the first operating point region 210 under ideal conditions in which any external loads other than the plurality of first switching elements S11, S12, S13, S14, S15, and S16 included in the first inverter 10 are not considered. For example, in order to output the maximum torque τₘₐₓ in the first operating point region 210 by controlling the first inverter 10 while the third switching elements S41, S42 and S43 are turned on, the controller 70 should control the first inverter 10 under the ideal conditions. The maximum torque τₘₐₓ can be output in the first operating point region 210 under ideal conditions in which the on-resistances of the third switching elements S41, S42, and S43 included in the mode switch 40 are not considered. The on-resistances of the switching elements S41, S42, and S43 will be described in more detail with reference to FIG. 3, and the driving mode switching criterion considering the on-resistances of the third switching elements S41, S42, and S43 will be described in more detail with reference to FIG. 4 and FIG. 5.

FIG. 3 is a circuit diagram of the motor driving device according to an exemplary embodiment of the present disclosure when the motor driving device operates in the CEW mode.

Referring to FIG. 3, the first ends of the windings L1, L2, and L3 of the motor 30 are connected to the plurality of first switching elements S11, S12, S13, S14, S15, and S16, and the second ends thereof are connected to the plurality of third switching elements S41, S42, and S43. Here, the third switching elements S41, S42, and S43 are in an ON state, and each of the third switching elements S41, S42, and S43 may have an on-resistance internally. The on-resistances of the third switching elements S41, S42, and S43 may vary depending on the temperature. Therefore, as the on-resistance of each of the third switching elements S41, S42, and S43 increases, the amount of current supplied from the first inverter 10 to the motor 30 decreases, and accordingly, the torque that can be output from the motor 30 may also decrease.

As illustrated in FIG. 2, the maximum torque τₘₐₓ that can be output in the first operating point region 210 may be a result that does not take into account the on-resistances of the plurality of third switching elements S41, S42, and S43 described above. That is, the torque of the motor 30 that can be output according to the controller 70 controlling the first inverter 10 without controlling the second inverter 20 may be lower than the maximum torque τₘₐₓ. This will be described in more detail below with reference to FIG. 4 and FIG. 5.

FIG. 4 shows a third operating point region 410 and a fourth operating point region 420 that take into account the on-resistances of the plurality of third switching elements S41, S42, and S43 on a graph of the command torque and reverse magnetic flux of the motor according to an exemplary embodiment of the present disclosure.

The third operating point region 410 corresponds to the CEW mode, similar to the first operating point region 210. The motor driving device according to an exemplary embodiment of the present disclosure can generate a required driving torque by controlling the first inverter 10 without controlling the second inverter 20 in the third operating point region 410. However, unlike the first operating point region 210, in the third operating point region 410, a lower torque τ_{T}_{₁} than the maximum torque τₘₐₓ can be output. This is because the current flowing through each of the windings L1, L2, and L3 of the motor 30 can be limited in consideration of the on-resistances of the plurality of third switching elements S41, S42, and S43.

The fourth operating point region 420 corresponds to the OEW mode, similar to the second operating point region 220. The motor driving device according to an exemplary embodiment of the present disclosure can generate a necessary driving torque by controlling the first inverter 10 and the second inverter 20 together in the fourth operating point region 420. Unlike the second operating point region 220 illustrated in FIG. 2, the fourth operating point region 420 may also include a low-speed range with low magnetic flux. As described above, even in a low-speed range, there is a limit to outputting the maximum torque τₘₐₓ by controlling the first inverter 10 without controlling the second inverter 20, and thus the controller 70 must additionally operate the second inverter 20 to output the maximum torque τₘₐₓ required by the motor 30.

However, the third operating point region 410 illustrated in FIG. 4 does not take into account that the on-resistances of the plurality of third switching elements S41, S42, and S43 vary depending on the temperature. That is, FIG. 4 shows an operating point region determined in consideration of the on-resistance characteristics when the third switching elements S41, S42, and S43 operate at the maximum allowable operating temperature T₁. Hereinafter, an operating point region of the motor 30 reflecting the on-resistances of the plurality of third switching elements S41, S42, and S43 determined at different temperatures will be described in more detail with reference to FIG. 5.

FIG. 5 shows change in the third operating point region 410 in consideration of the on-resistances according to the temperature change in the plurality of third switching elements S41, S42, and S43 in an exemplary embodiment of the present disclosure.

Referring to FIG. 5, the third operating point region 410 is an operating point region at T₁, and a fifth operating point region 510 is an operating point region at T₂. The fifth operating point region 510 corresponds to the CEW mode, similar to the third operating point region 410.

T₁ may be the maximum operating temperature allowable by the plurality of third switching elements S41, S42, and S43, and T₂ may be the minimum allowable operating temperature, but this is exemplary and the present disclosure is not necessarily limited thereto.

As described above, the third operating point region 410 may vary depending on the temperature, which is a phenomenon that occurs when the third switching elements S41, S42, and S43 have a characteristic in which the on-resistances thereof change depending on the temperature. Generally, as the temperature of the third switching elements S41, S42, and S43 decreases, the on-resistance may decrease. When the on-resistance of each of the third switching elements S41, S42, and S43 decreases while the motor 30 is driven in the CEW mode, the current flowing through each of the windings L1, L2, and L3 of the motor 30 may increase. When the current flowing through each of the windings L1, L2, and L3 of the motor 30 increases, the output torque of the motor 30 may also increase. Therefore, the torque that can be output when the controller 70 controls the first inverter 10 to drive the motor 30 without controlling the second inverter 20, may vary depending on the temperature of the third switching elements S41, S42, and S43.

The fifth operating point region 510 differs from the third operating point region 410 in that the maximum torque τ_{T}_{₂} that can be output in the fifth operating point region 510 is greater than the maximum torque τ_{T}_{₁} that can be output in the third operating point region 410, which is a result that can be derived based on the above description. Furthermore, the fact that the operating point region corresponding to the CEW mode can change between the third operating point region 410 and the fifth operating point region 510 according to temperature change can be naturally derived by considering the conditions and relationships described above.

Hereinafter, a process of determining the driving mode of the motor 30 by considering that the operating point region corresponding to the CEW mode described above can change depending on the temperature of the mode switch 40, more specifically, the plurality of third switching elements S41, S42, and S43, will be described.

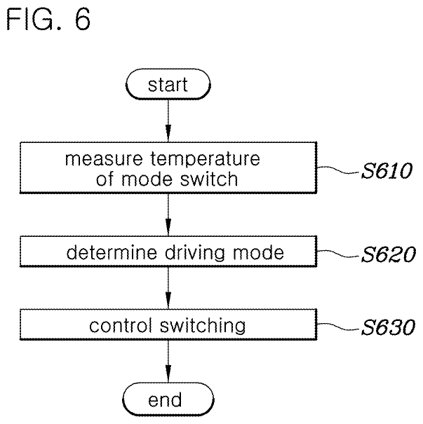

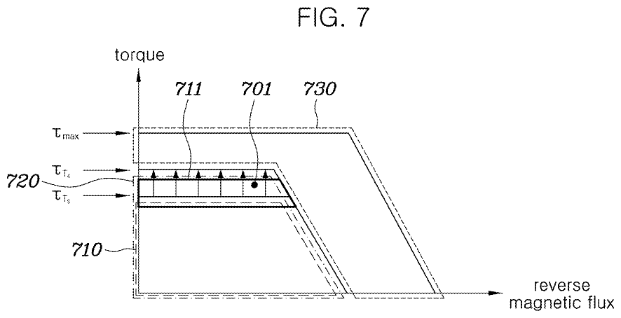

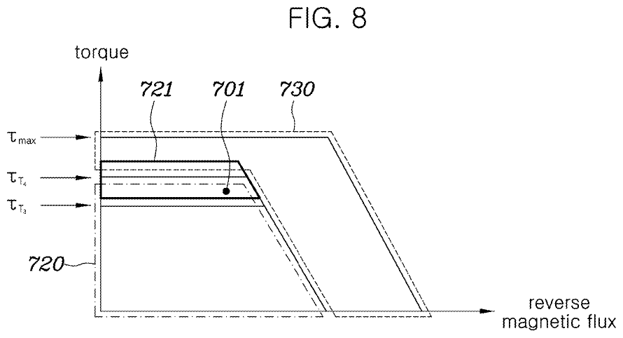

FIG. 6 shows an example of a process in which the controller 70 is configured to determine a driving mode of the motor 30 and is configured to control the third switching elements S41, S42, and S43 according to an exemplary embodiment of the present disclosure.

Referring to FIG. 6, first, the sensor 80 may measure the temperature of the mode switch 40 and transmit the measured temperature information to the controller 70 (S610). The controller 70 may be configured to determine a driving mode based on the received temperature information and an operating parameter value of the motor 30 (S620). Thereafter, the controller 70 may control the third switching elements S41, S42, and S43 based on the determined driving mode (S630). The step S620 of determining the driving mode by the controller 70 and the step of controlling the third switching elements S41, S42, and S43 based on the determined driving mode will be described in more detail later.

First, the controller 70 may be configured to determine a driving mode switching criterion for the motor 30 based on the temperature information of the mode switch 40 received from the sensor 80. Here, determining the driving mode switching criterion may mean that an operating point region corresponding to the temperature information received from the sensor 80 among operating point regions corresponding to the CEW mode that change according to temperature, as illustrated in FIG. 5, is determined as the operating point region in which the CEW mode is executed. Thereafter, the controller 70 may be configured to determine the driving mode of the motor 30 based on the determined driving mode switching criterion and the operating parameter value of the motor 30. Here, operating parameter values of the motor 30 may include at least one of the torque, reverse magnetic flux, or rotation speed of the motor 30.

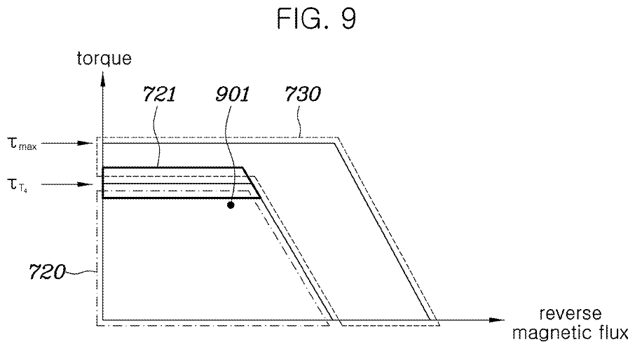

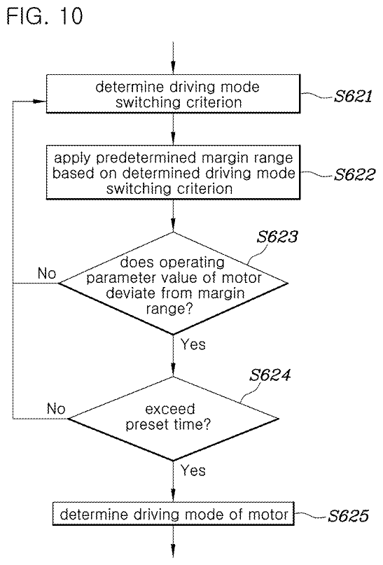

If the controller 70 according to an exemplary embodiment of the present disclosure reacts in real time to temperature change in the mode switch 40 and immediately switches the driving mode, the driving mode changes frequently, which may aggravate control instability and lower the overall system efficiency. To prevent this, the controller 70 according to an exemplary embodiment of the present disclosure may apply a predetermined margin range to the driving mode switching criterion and determine the driving mode based on whether the operating point corresponding to the operating parameter value of the motor 30 deviates from the applied margin range for a preset time period or longer, which will be described in more detail with reference to FIG. 7, FIG. 8, FIG. 9 and FIG. 10.

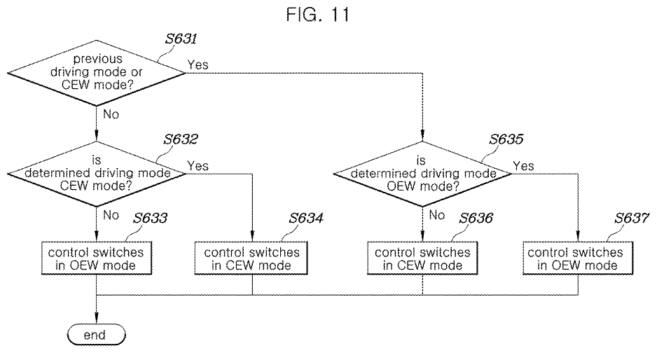

Upon determining the driving mode, the controller 70 may control the third switching elements S41, S42, and S43 by comparing the determined driving mode with the driving mode determined in the previous control cycle. If the driving mode determined in the previous control cycle is different from the currently determined driving mode, the controller 70 may control the third switching elements S41, S42, and S43 based on the currently determined driving mode, and if the driving mode determined in the previous control cycle is the same as the currently determined driving mode, the controller 70 may control the third switching elements S41, S42, and S43 based on the driving mode determined in the previous control cycle. This will be described in more detail with reference to FIG. 11.

FIG. 7, FIG. 8, and FIG. 9 illustrate a method of determining a driving mode by applying a predetermined margin range to the driving mode switching criterion determined by the controller 70 according to an exemplary embodiment of the present disclosure.

Referring to FIG. 7, the x-axis represents the reverse magnetic flux of the motor 30 and the y-axis represents the command torque of the motor 30, similar to the graph illustrated above. A sixth operating point region 710 is an operating point region corresponding to the CEW mode determined at temperature T₃, a seventh operating point region 720 is an operating point region corresponding to the CEW mode determined at temperature T₄, and an eighth operating point region 730 is an operating point region corresponding to the OEW mode determined at temperature T₄. In general, T₄ may be less than T₃, but this is exemplary and the present disclosure is not necessarily limited thereto. FIG. 7 shows that the operating point 701 corresponding to the parameter value of the motor 30 is located within a first margin range 711 applied to the existing driving mode determination criterion. A margin range applied to the driving mode switching criterion determined at T₄ is shown in FIG. 8.

FIG. 8 shows a second margin range 721 applied to the driving mode switching criterion corresponding to temperature T₄ under the same conditions as FIG. 7. The operating point 701 corresponding to the parameter value of the motor 30 is also located within the second margin range 721. As illustrated in FIG. 7 and FIG. 8, based on the operating point 701 of the motor 30 belonging to both the first margin range 711 and the second margin range 721, the controller 70 may be configured to determine a driving mode by receiving temperature information of the mode switch 40 from the sensor 80 instead of determining the driving mode based on the determined driving mode switching criterion and the parameter value of the motor 30. As described above, if the driving mode switching criterion is determined for each control cycle and the driving mode is immediately switched in response thereto, the overall system efficiency may be reduced. Therefore, in order to improve the overall system efficiency, even if the driving mode switching criterion is changed, the actual driving mode change needs to be limited to when the change is sufficiently meaningful. To the present end, the method described above is merely an example, and there may be various methods for improving the overall system efficiency.

The predetermined margin range applied according to the driving mode switching criterion may be preset in the controller 70, but this is exemplary and the present disclosure is not necessarily limited thereto.

FIG. 9 shows that the operating point 901 of the motor 30 has been changed, unlike FIG. 8. The changed operating point 901 of the motor 30 is outside the second margin range 721. Here, if the state in which the changed operating point 901 is outside the second margin range 721 is maintained for longer than a preset time, the controller 70 may be configured to determine a driving mode based on the determined driving mode switching criterion and the changed operating point 901. If the state in which the changed operating point 901 of the motor 30 that deviates from the second margin range 721 is maintained for longer than the preset time in FIG. 9, the controller 70 may be configured to determine the driving mode as the CEW mode and turn on the switching elements S41, S42, and S43 to control the first inverter 10 among the first inverter 10 and the second inverter 20 to control operation of the motor 30. Here, while the first inverter 10 is being controlled, the third switching elements S41, S42 and S43 are turned on.

FIG. 10 illustrates an example of a process in which the controller 70 is configured to determine a driving mode according to an exemplary embodiment of the present disclosure in more detail.

Referring to FIG. 10, the controller 70 may be configured to determine a driving mode switching criterion based on the temperature of the mode switch 40 received from the sensor 80 (S621). Thereafter, the controller 70 may apply a predetermined margin range based on the determined driving mode switching criterion as described above with reference to FIG. 7, FIG. 8, and FIG. 9 (S622). The controller 70 may be configured to determine whether the operating point determined according to the operating parameter value of the motor 30 is out of the predetermined margin range (S623). Based on the operating point of the motor 30 being out of the margin range (Yes in S623), the controller 70 may be configured to determine whether the operating point is out of the margin range for more than a preset time (S624). Based on the operating point being out of the margin range for more than the preset time (Yes in S624), the controller 70 may be configured to determine a driving mode based on the operating point of the motor 30 and the driving mode switching criterion (S625).

On the other hand, if the operating point belongs to the margin range (No in S623) or the operating point falls within the margin range within the preset time (No in S624), the controller 70 may re-determine the driving mode switching criterion based on the temperature of the mode switch 40 received from the sensor 80 (S621).

FIG. 11 illustrates an example of a process of controlling the third switching elements S41, S42, and S43 based on the driving mode determined by the controller 70 according to an exemplary embodiment of the present disclosure in more detail.

First, the controller 70 may be configured to determine whether the driving mode according to the previous control cycle is the CEW mode (S631).

The controller 70 may be configured to determine whether the determined driving mode is the CEW mode (S632) based on the driving mode according to the previous control cycle being the OEW mode (No in S631).

Based on the determined driving mode being the OEW mode (No in S632), the controller 70 may turn off the third switching elements S41, S42, and S43 based on the OEW mode since the OEW mode that is the driving mode determined according to the previous control cycle is the same as the determined driving mode (S633).

On the other hand, based on the determined driving mode being the CEW mode (Yes in S632), the controller 70 may turn on the third switching elements S41, S42, and S43 based on the CEW mode that is the determined driving mode since the determined driving mode is different from the OEW mode that is the driving mode determined according to the previous control cycle (S634).

The controller 70 may be configured to determine whether the determined driving mode is the OEW mode (S635) based on the driving mode determined according to the previous control cycle being the CEW mode (Yes in S631).

Based on the determined driving mode being the CEW mode (No in S635), the controller 70 may turn on the third switching elements S41, S42, and S43 based on the CEW mode since the determined driving mode is the same as the CEW mode, which is the driving mode determined according to the previous control cycle (S636).

On the other hand, based on the determined driving mode being the OEW mode (Yes in S635), the controller 70 may turn off the third switching elements S41, S42, and S43 based on the OEW mode that is the determined driving mode since the determined driving mode is different from the CEW mode, which is the driving mode determined according to the previous control cycle (S637).

In summary, the controller 70 may compare the driving mode determined according to the previous control cycle with the currently determined driving mode, maintain the driving mode determined according to the previous control cycle if the two driving modes are the same, and control the third switching elements S41, S42, and S43 based on the currently determined driving mode if the two driving modes are different.

According to the embodiments described above, the present disclosure can reduce the power consumption rate by driving the motor 30 in the CEW mode in consideration of the temperature of the third switching elements S41, S42, and S43 even in a low-speed range in which the reverse magnetic flux of the motor 30 is low, thereby controlling the operation of the motor 30 more efficiently.

In an exemplary embodiment of the present disclosure, the motor driving device can drive a motor more efficiently based on a driving mode determined in consideration of the temperature of the mode switch.

The effects that can be obtained through the embodiments of the present disclosure are not limited to the effects mentioned above, and other effects that are not mentioned can be clearly understood by a person having ordinary skill in the art from the description below.

Although the exemplary embodiments of the present disclosure have been disclosed for illustrative purposes, those skilled in the art will appreciate that various modifications, additions and substitutions are possible, without departing from the scope and spirit of the present disclosure as disclosed in the accompanying claims.

What is claimed is:

1. A motor driving device comprising:
a motor including a plurality of windings;
a first inverter connected to a first end of each of the plurality of windings;
a second inverter connected to a second end of each of the plurality of windings;
a mode switch including a plurality of switching elements, each first end of the plurality of switching elements being interconnected, and second ends of the plurality of switching elements being connected to the second ends of the plurality of windings; and
a controller operatively connected to the first inverter, the second inverter and mode switch, determining a driving mode of the motor based on at least one operating parameter value of the motor and a temperature of the mode switch and controlling the plurality of switching elements based on the determined driving mode.

2. The motor driving device of claim 1, wherein the controller determines a driving mode switching criterion of the motor based on the temperature of the mode switch, and determines the driving mode of the motor based on the determined driving mode switching criterion and the at least one operating parameter value of the motor.

3. The motor driving device of claim 2, wherein the controller applies a predetermined margin range to the determined driving mode switching criterion, and determines the driving mode of the motor based on whether the at least one operating parameter value of the motor deviates from the margin range for a predetermined time period or longer than the predetermined time period.

4. The motor driving device of claim 2, wherein the at least one operating parameter value of the motor include at least one of a torque, a reverse magnetic flux, or a rotation speed of the motor.

5. The motor driving device of claim 4, wherein the driving mode switching criterion is determined based on relationships between the torque and the reverse magnetic flux of the motor or relationships between the torque and the rotation speed of the motor corresponding to different temperatures in a preset temperature range of the mode switch.

6. The motor driving device of claim 1, wherein the driving mode includes:
a closed end winding (CEW) mode in which the plurality of switching elements are turned on by the controller to form a Y-connection and the first inverter is controlled by the controller to drive the motor; and
an open end winding (OEW) mode in which the plurality of switching elements are turned off by the controller and the first inverter and the second inverter are controlled by the controller to drive the motor.

7. The motor driving device of claim 1, wherein the controller controls the plurality of switching elements in the determined driving mode, based on the determined driving mode being different from a driving mode of the motor determined in a previous control cycle.

8. The motor driving device of claim 1, wherein the controller controls the plurality of switching elements in the driving mode determined in the previous control cycle, based on the driving mode of the motor determined in the previous control cycle being the same as the determined driving mode.

9. A method of controlling a motor driving device including a motor including a plurality of windings, a first inverter connected to a first end of each of the plurality of windings, a second inverter connected to a second end of each of the plurality of windings, a mode switch including a plurality of switching elements, each first end of the plurality of switching elements being interconnected, and second ends of the plurality of switching elements being connected to the second ends of the plurality of windings, and a controller, the method comprising:
determining, by the controller, a driving mode of the motor based on at least one operating parameter value of the motor and a temperature of the mode switch; and
controlling, by the controller, the plurality of switching elements based on the determined driving mode.

10. The method of claim 9, wherein the determining of the driving mode includes:
determining, by the controller, a driving mode switching criterion of the motor based on the temperature of the mode switch; and
determining, by the controller, the driving mode of the motor based on the determined driving mode switching criterion and the at least one operating parameter value of the motor.

11. The method of claim 10, wherein the determining of the driving mode includes:
applying, by the controller, a predetermined margin range to the determined driving mode switching criterion; and
determining, by the controller, the driving mode of the motor based on whether the at least one operating parameter value of the motor deviates from the margin range for a predetermined time period or longer than the predetermined time period.

12. The method of claim 10, wherein the at least one operating parameter values of the motor include at least one of a torque, a reverse magnetic flux, or a rotation speed of the motor.

13. The method of claim 12, wherein the driving mode switching criterion is determined based on relationships between the torque and the reverse magnetic flux of the motor or relationships between the torque and the rotation speed of the motor corresponding to different temperatures in a preset temperature range of the mode switch.

14. The method of claim 9, wherein the driving mode includes:
a closed end winding (CEW) mode in which the plurality of switching elements are turned on by the controller to form a Y-connection and the first inverter is controlled by the controller to drive the motor; and
an open end winding (OEW) mode in which the plurality of switching elements are turned off by the controller and the first inverter and the second inverter are controlled by the controller to drive the motor.

15. The method of claim 9, wherein the controlling of the plurality of switching elements includes controlling, by the controller, the plurality of switching elements in the determined driving mode, based on the determined driving mode being different from a driving mode of the motor determined in a previous control cycle.

16. The method of claim 9, wherein the controlling of the plurality of switching elements includes controlling, by the controller, the plurality of switching elements in the driving mode determined in the previous control cycle, based on the driving mode of the motor determined in the previous control cycle being the same as the determined driving mode.
